(19) United States
(12) Patent Application Publication
(10) Pub. No.: US 2023/0216538 A1
(43) Pub. Date: Jul. 6, 2023

(54) System and method to optimize the Digital Subscriber Line performance by negotiating the transmitter Power Back-Off

(71) Applicant: Realtek Semiconductor Corp., Hsinchu (TW)

(72) Inventor: Meng-Chieh Tsao, San Jose, CA (US)

(21) Appl. No.: 17/565,511

(22) Filed: Dec. 30, 2021

(51) Int. Cl. H04B 3/32; H04B 3/487; H04B 3/54; H04B 17/336

(52) U.S. Cl. CPC H04B 3/32; H04B 3/487; H04B 3/542; H04B 17/336

(57) ABSTRACT

For Digital Subscriber Line (DSL), the whole system needs to deal with crosstalk of the neighboring pairs in the same bundle. A mechanism named Dynamic Spectrum Management (DSM) is proposed to optimize the overall performance of many subscriber lines, by means of lowering some unnecessary power spectrum density (PSD) on some lines and thus reducing their crosstalk to others. The decisions of the reduction (or power back-off, PBO) usually base on the loop distances between Central Office (CO) and the subscriber's premises. The shorter the distance, the lower the power. However, this does not consider the fact of each individual line's quality, i.e., its background noise or external interferences. The transceivers are able to collect such information. A negotiation process includes this information to adjust the power cutback, so that the cutback won't degrade the potential optimal performance of such lines.

### FIELD OF THE INVENTION

This present invention relates to high-speed synchronous data transmission systems that use multiple signal subcarriers, such as those operating over Digital Subscriber Lines (DSL). More particularly, this invention is directed to the balance of global and local performance optimizations of DSL systems, especially Very High-Bit-Rate Digital Subscriber Line (VDSL) and future variants that suffer more from crosstalk in the whole system.

### BACKGROUND OF THE INVENTION

Digital Subscriber Lines (DSL) have been popular since ADSL (Asymmetric DSL) was invented and standardized in 1999. It was a great technology leap from a voice band modem, which only utilizes the voice band up to 4 KHz. In many countries in the world, it gained immediate popularity to provide broadband internet to each home, with the fact of wide existing deployment of telephone wires. The broadband speed was lifted from a mere 50 Kbps by a voice band modem, to 8 Mbps by an ADSL modem with 1 MHz bandwidth. Throughout the years, DSL technology continued to advance. With more advanced technology, more and higher bandwidths are used to increase the attainable speeds. Baseband bandwidth started from 1 MHz to 2 MHz (ADSL2+), to 8 MHz/17 MHz/35 MHz (VDSL2), and to 106 MHz/212 MHz (GFAST). The bandwidth will be evenly used by a set of subcarriers with orthogonal frequencies, and such technology is called Discrete Multi-Tone (DMT). Along with the technology advances, it was found that the crosstalk among telephone wires in the same cable bundle posed an increasing problem when the using bandwidth got higher. To achieve an overall optimal system performance, a later technology called vectoring was invented to cancel most of the crosstalk within the same DSL technology. Crosstalk can be evaluated on subcarrier frequency level within the same bandwidth. With a good estimation of crosstalk, the Digital Subscriber Line Access Multiplexer (DSLAM, residing in a central office) side may do a good cancellation on most of the unwanted crosstalk. This topic is becoming more and more important as the involving bandwidth will only go up higher for uprising new technologies, and the crosstalk will get more and more serious.

In order to deal with this increasing crosstalk interferences among the whole DSL system, several ideas have been developed and implemented. It is called the Dynamic Spectrum Management (DSM), which was mainly contributed by Stanford professor John Cioffi and his team. The techniques for DSM are categorized into levels of coordination. In Level 0, there is no coordination, and each user views other users' signals as noise and seeks to maximize its own data rate in a distributed manner. This is called Iterative Water-filling (IWF). The next is Level 1, a Spectrum Management Center (SMC) at DSLAM side can coordinate some power back-off for short-distance users located close to central office (CO) as it is not needed to reach their service rates. This in turns reduces the crosstalk into other longer-distance users, who need the full power for their service rates. Then it goes to Level 2, when the SMC can coordinate the spectra of all modems centrally. It applies so-called Optimal Spectrum Balancing (OSB), attempting to maximize the weighted sum of rates of all users. SMC may decide both upstream and downstream PSDs to achieve that. For Level 3 DSM, there is the complete coordination, or ‘vectoring’ occurs as all modems terminate at the same DSLAM, which results in a MIMO channel.

In the field application of ADSL, the first generation of ADSL (or G.DMT) has only considered a downstream power cutback/politeness. It can be viewed as DSM Level 0, as it is merely to avoid signal saturation in the shortest loop lengths. The second generation of ADSL (ADSL2 and ADSL2plus) has DSM Level 1 consideration, as it provides both the upstream and downstream power cutback and can be decided by both central office and customer premises equipment (CPE) sides together. However, it only has one-way negotiation, meaning that if one side chooses larger power cut then it will be the final decision.

In the field application of VDSL2, it can be considered as DSM Level 2. The detailed power spectrum shapes of both upstream and downstream may be decided by CO side, with the negotiation of both CO and CPE. Later with the vectoring standard, VDSL2 also has DSM Level 3 implemented. A Vectoring Control Entity (VCE), residing at CO site, controls all connected CPEs with aligned symbol boundaries so that the desired signals and crosstalk are orthogonal, and crosstalk is cancelled by matrix operations. The overall of all users' rates are significantly improved by these DSM techniques. The high frequency bands suffering crosstalk among users are much improved by vectoring that cancels most of the crosstalk. This enables the overall average user data rates at least 95% of what they should get as if there exists no crosstalk interference. Comparably, without these techniques applied, the overall average user data rates may suffer 30˜50% degradations by mutual crosstalk among them.

Despite these prior art teachings, however, there exists an area that has not yet been considered. The DSM Level 2 considers the power back-off or PSD shaping strictly by the electrical length (the estimated loop distance between CO and CPE). For shorter loop distance, the PSD or power will tend to be lower, as it only needs less power to reach its service requirements; this power and power spectrum density (PSD) reduction also helps the overall system because its crosstalk into other users is also reduced. The final decision of power/PSD is at CO side, while CPE can only negotiate and suggest even lower power than CO side. If the line condition is not good, for example it has some static environment noise or radio frequency interference, the reduced power/PSD may leave it unable to reach its desired optimal rate. It may even be unable to reach its service rate.

### SUMMARY OF THE INVENTION

An object of the present invention, therefore, is to provide an improved system and method for maintaining an optimal rate with balanced power and power spectrum density (PSD) reduction due to shorter distance and the consideration of its own noise floor.

Another object of the present invention is to provide an improved initialization exchange protocol, to facilitate the final decision of the power and PSD levels by considering both electrical length and the noise profile.

A related object of the present invention is to provide an improved system and method for balancing the far-end crosstalk (FEXT) of the overall system and each individual's noise characteristics.

A further object of the present invention is to apply the above methods in any high-speed DSL systems which may need the power reduction control for system FEXT performance, while also achieving individual DSL line's optimal performance.

A system of the present invention therefore eliminates the possible suboptimal rate degradation by the sole decision of power reductions by referencing the estimated electrical length between CO and CPE sides. In a preferred embodiment, the signals carry information in accordance with known protocols and standards. The system first includes a training protocol, which is used for the individual system to identify its characteristics, such as the loop distance, static environment noises, radio frequency interference, and so on. In the whole DSL system, the self-crosstalk is becoming more and more critical, and fortunately it can be greatly reduced by advanced DSM technologies. One important technique is to reduce the transmit powers or PSD levels for the lines with shorter distance between CO and CPE end terminals. Such technique is used for crosstalk mitigation for near-far problems; shorter distance means CPE is near CO and it creates stronger crosstalk to farther CPEs. These lines don't need the full powers or PSD levels to achieve their service rate, due to their much fewer signal attenuations. So-called power back-off (PBO) can be implemented by both ends' transmitters, with the knowledge of the estimated loop distance, or electrical length. Such PBO technique is effective to reduce the strong crosstalk (self-FEXT) from these shorter lines into other longer lines. Both CO and CPE end terminals measure their received signals, with the knowledge of the peer's transmitted PSD level, they further estimate the signal attenuations and the loop distance. Both CO and CPE end terminals also measure their noises, or the Signal-to-Noise-Ratio (SNR), to decide whether the PBO is able to prevent them to reach the target service rates.

Without the invention, the PBOs decided solely by the loop distance might cause the PSD to be too low, where the reduced signal levels compared to its noise levels are not sufficient to provide enough SNR to meet its service rates. This is not desired, as the quality of such short loops should be very sufficient to provide the needed service. Once they know the resulting SNR possibly fail to support their service rates, it requires a mechanism to adjust the PSD or PBO so that the newly transmitted signal has the desired level for the required SNR.

In this regard, one implementation adds an extra exchange phase, once the receivers gather the noise information and SNR, to adjust the peer's transmitter PSD if needed. In the VDSL standard, the protocol for the PSD/PBO decision is done in the Channel Discovery stage, which is the first stage of initialization. The signal measurement and noise measurement may be performed in this stage. But in the current protocol, the self-FEXT is present in this stage, which will mislead the noise measurement. The self-FEXT will be measured and cancelled in the second stage, Training & Analysis stage. Until then, the real noise measurement and resulting SNR are meaningful for final service. Therefore, the proposed implementation may include a retrain mechanism to restart a new initialization process so that the PSD/PBO decision may take the noise into consideration. This process may be optional if the measured noise will not affect its targeted service rates given the current PBO.

In the Channel Discovery stage, several messages exchange between CO and CPE ends. O-SIGNATURE is the first message in this stage. It conveys the CO's setting about PSD masks, UPBO (Upstream PBO) parameters, and many others. CPE may start measuring the signal in O-SIGNATURE; with the actual PSD information in this message that CO is sending, CPE may derive the channel attenuation and thus derive the loop distance/electrical length. The channel or loop attenuation is the signal gap between the transmitter's PSD and the receiver's PSD levels. The physical loop distance or electrical length is a single value kl0 representing the loop attenuation across the used bandwidths. There is a predefined rule to decide the PBO which involves UPBO parameters a and b, the electrical length kl0 and the subcarrier frequency. Next, CPE starts sending its first message, R-MSG1, with the actual PSD/UPBO it is applying. CO then in turn measure the signal, together with the PSD information in R-MSG1, it derives the channel attenuation and loop distance (or electrical length). CPE will also convey its estimated electrical length to CO side, and CO will make the final decision of electrical length in next message O-UPDATE. CO may assign a PSD ceiling to further limit the upstream PSD. The Upstream PBO (UPBO) is finalized by this final electrical length and shall be applied by CPE end in the beginning of Training stage. The Downstream PBO (DPBO) is finalized after receiving R-UPDATE, in which CPE may request a downstream PSD ceiling, and shall be applied by CO end in the beginning of Training stage as well. In the O-PRM, CO conveys the final decided PSD/DPBO to CPE end; likewise, in R-PRM CPE conveys the final decided PSD/UPBO to CO end.

As noted above, both sides shall measure the noises in additional to the signals. To better measure the real noises after self-FEXT is cancelled, this process may take place in the second stage of Training & Analysis. CO side will coordinate all the lines it connects to and try to cancel the FEXT to its best. Then both sides measure the real residual noises, and then decide whether the SNR is enough to support its target service rate. There can be two possibilities: (1) the SNR is enough, so the PBO/PSD levels are proper, and it proceeds to the final stage; or (2) the SNR is not enough, so the PBO/PSD levels need adjustment. In the latter case, a retrain may be needed to apply the adjustment since the PSD levels are finalized in the beginning of Training & Analysis stage. During the retrain, this adjustment may be implemented in the messages R-UPDATE and O-PRM. The R-UPDATE conveys the requested DPBO PSD upshift, in order to increase its received signal level and thus SNR. The O-PRM conveys the requested UPBO PSD upshift, to achieve the same purpose on the upstream direction. Both ends decide the final PBO PSD and apply them in the beginning of Training stage as mentioned.

Although the inventions are described below in a preferred embodiment involving a VDSL transceiver, it will be apparent to those skilled in the art the present invention would be beneficially used in many situations where it is necessary to reduce the risk of insufficient rates due to the power back-off.

### BRIEF DESCRIPTION OF THE DRAWINGS

FIG. 1 is a block diagram illustrating an embodiment of a typical DSL system and circuit and its connection to a peer system and circuit.

FIG. 2 is a block diagram illustrating an embodiment of a VDSL protocol stages and where the present invention may be implemented in accordance with the standard.

FIG. 3 depicts in flow chart form the general flow of the power/PSD decision defined in the standard.

FIG. 4 depicts in flow chart form the present invention of power/PSD decision with proposed additions.

FIG. 5 is the flow chart of the algorithms involved in this invention.

### DETAILED DESCRIPTION OF THE INVENTION

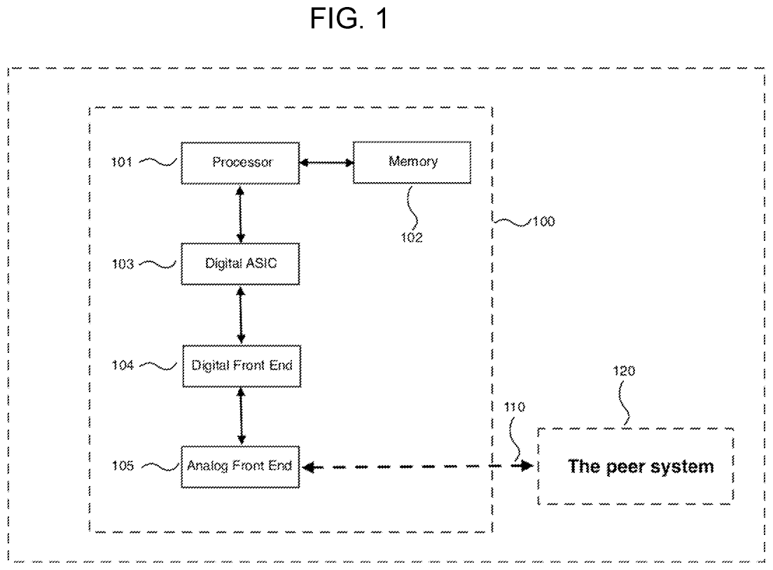

An embodiment of a system 100 of the present invention is illustrated in FIG. 1. System 100 is a typical DSL system, which consists of a central processor 101, a memory 102, a digital Application-Specific-Integrated-Circuit (ASIC) 103, a digital front end 104, and an analog front end 105. The processor 101 is in charge of all intelligent work needed, including the implementation of protocols, control of digital and analog ASIC designs, and performing important algorithms. Because of the lower quality of telephone circuit compared to the later Ethernet or Fiber, it is critical to have many innovative algorithms to be able to achieve the theoretical capacity limit of such medium. Hence, the protocol itself also tends to be complicated than other technologies. The central processor 101 contains the logics that are responsible for executing these algorithms and protocols. The presented invention of negotiating the PSD or PBO levels is an algorithm resides in the processor logics and its associated memory. DSL signals generated from the specifically designed integrated circuits pass through further digital and analog signal processing units, and finally are sent onto the telephone wire. Path 110 depicts this connection. On the other end, a similar embodiment of a system represents the peer DSL modem (i.e., peer system 120).

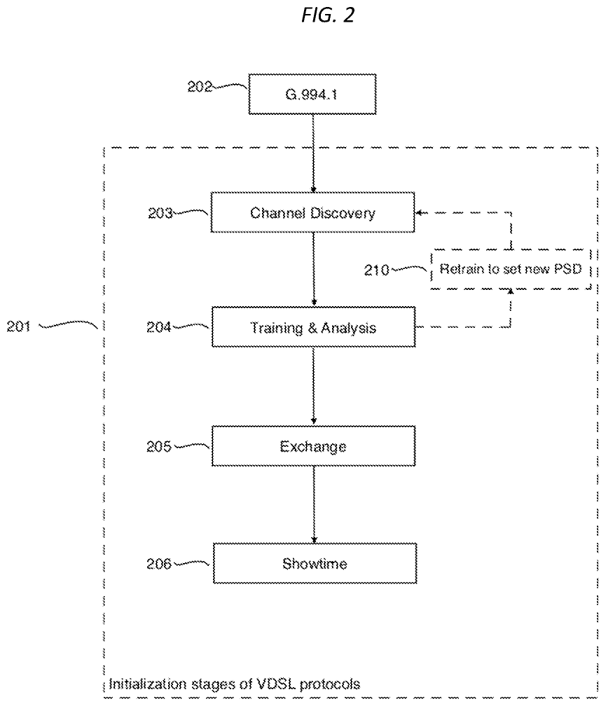

A preferred embodiment of a system 201 of the present invention is illustrated in FIG. 2. System 201 is to perform a VDSL protocol defined in standard ITU-T G.993.2. Block 202 is a common exchange protocol for all DSL related standards. It is called G.994.1, G.hs, or G.handshaking. Both sides use this protocol to identify each other's supporting capabilities. Once both sides agree on the VDSL capability, they continue to move on to VDSL protocol. Stage 203 is the first stage of VDSL protocol, Channel Discovery. In this stage, CO and CPE send their first signals and they both measure their received signals. At first, they send the non-valid data (or quiet) signals with a predefined period of time for the peer to prepare for detecting the first valid data (non-quiet) signals. After the time expired, they send the first predefined patterns of signals for the peer to detect and analyze. These signal detections and analyses are performed in time-domain signal processing, or in frequency-domain signal processing by applying the fast Fourier transform (FFT) on signals. CO and CPE will compute the mean and variance on these frequency-domain repeated patterns of signals. They analyze these patterns of signals to discover the channel characteristics including the electrical length. Further messages are exchanged to finalize the decided electrical length, and thus the decided PSD levels. The new PSD levels include PBO (UPBO/DPBO) and will be applied from the beginning of the next stage. Stage 204 is the second phase of VDSL protocol, Training & Analysis. In this stage, CO and CPE further train and fine-tune their receiver such as equalizers and gain controls. CO will also train their crosstalk cancellers, called pre-coders and post-coders. Vectoring Control Entity (VCE) at CO performs matrix operations on upstream direction post-coders, and on downstream direction pre-coders. After this crosstalk cancellation stage in Training & Analysis of VDSL protocol, the real residual SNR and noise floor can be measured.

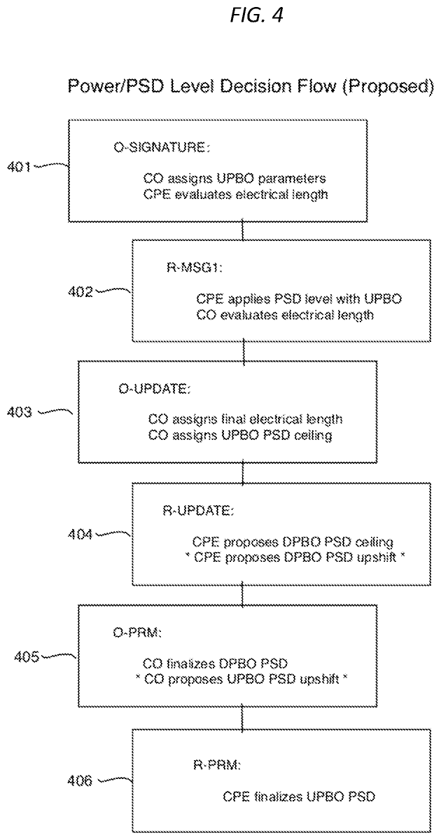

The present invention introduces a new examination on the SNR here, to ensure its target service rates will not be compromised by the PBO. Block 210 (i.e., retrain to set new PSD) is the additional stage if the PBO is not proper, it has to go back to Channel Discovery stage to negotiate the PBO again. A detailed negotiation will be explained in FIG. 4. This additional stage 210 may not be necessary if the PBO is examined proper for its service, then it may move on to the next stage.

Stage 205 is the third stage, Exchange. Both ends will finalize all remaining parameters and prepare for the entry of Showtime process. They will also exchange these parameters so that the peer may prepare its transmitter as well. If everything is fine, they enter stage 206, which is Showtime. At this point, the training and initialization are completed, and the data transfer and services may start. In the embodiment, any of the Channel Discovery stage, the Training & Analysis stage, and the Exchange stage can be an initialization stages of VDSL protocols performed by the system 100.

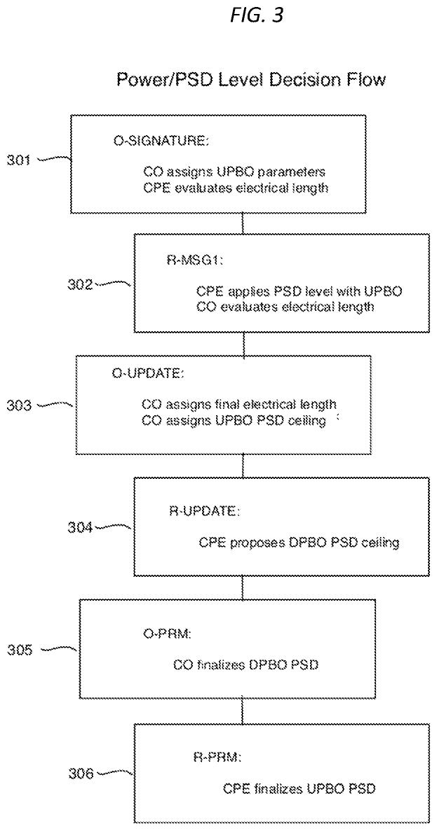

FIG. 3 is a flow chart illustrating the detailed message exchanges in the Channel Discovery stage (FIG. 2 Block 203). Block 301 is the first message in this stage, which CO sends to CPE. It is also the first signal from CO to CPE, for the purpose of initial locking and measurements. CO embeds some information in this message, to inform CPE about the PSD level it sends. In this regard, CPE can estimate the signal and loop attenuations, and further derive the electrical length and the transmitter UPBO PSD. Block 302 is the first message that CPE will send back to CO side. This allows CO to perform the initial locking and measurements. It also embeds the information about the UPBO PSD level CPE sends out. CO can estimate the signal and loop attenuations to derive the electrical length. In the R-MSG1 message, CPE will also convey its estimated electrical length, so that CO can make a final decision on the accuracy of electrical length. Next, in Block 303 CO's second message assigns the final electrical length for CPE to follow, and a ceiling of UPBO PSD level. The ceiling provides an upper bound to limit the UPBO PSD. In Block 304, CPE in turn sends its R-UPDATE message which proposes a ceiling of DPBO PSD level. Finally, in Blocks 305 and 306, both sides convey the messages to another about their final PBO PSD shapes, putting the electrical length and the ceiling into consideration. This concludes the decision flow of the transmitter power and PSD levels defined in VDSL standards.

FIG. 4 is a flow chart of the message exchange in the Channel Discovery stage. Blocks 401, 402 and 403 are to previous-described blocks 301, 302 and 303 respectively. Block 404, the R-UPDATE message, has a new message field for CPE to propose a DPBO PSD upshift. This upshift is the implementation of this invention, if this CPE measures its noise floor and received DPBO is unable to support its optimal rate, it may propose a nonzero upshift on the PSD level. CO can take this into consideration in its final DPBO PSD. Next in Block 405, the O-PRM message, CO conveys its final decided DPBO PSD shape, and may choose to propose a nonzero upshift on UPBO PSD level too after it measures its noise floor. Finally, the Block 406 R-PRM message has no change from Block 306.

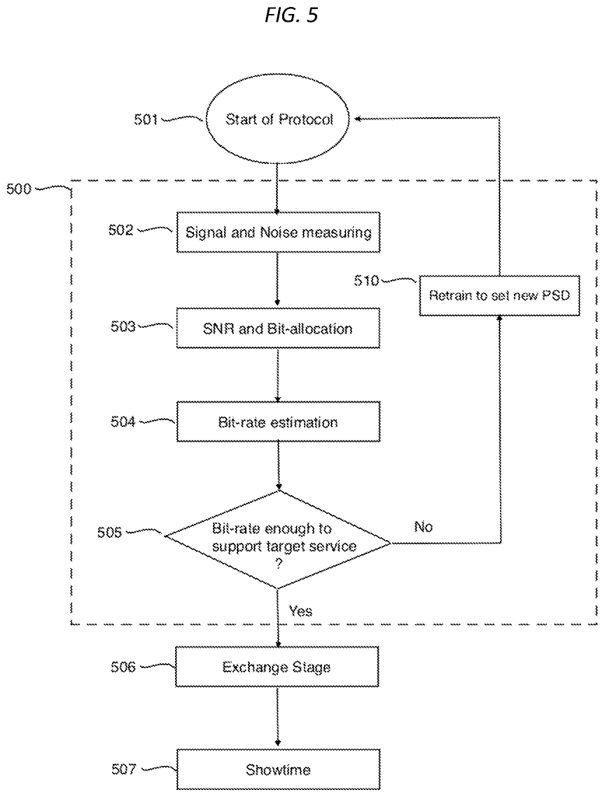

FIG. 5 depicts the flow of the involved algorithms in this invention. Block 500 summarizes the utilized algorithms. Block 501 is the start point of the protocol, where in VDSL it is the Channel Discovery stage. Block 502 is the Signal and Noise measurements, whereas signal and noise can be measured separately in different proper time. Block 503 is the SNR estimation and the Bit-load allocation algorithms. SNR can be simply derived by the difference of signal and noise per subcarrier obtained above, or other more advanced techniques. A simple bit-load allocation per subcarrier can be obtained proportional to the subcarrier's SNR. Once the data bit-load allocation per subcarrier can be determined, an estimate of the potential data rates can be obtained by summing up the data bits per subcarrier over a set of subcarriers at Block 504. The sum of the data bits represents the total data bits of a symbol, and the attainable data rates are obtained by the multiplication of the symbol rate (number of symbols per second) and the total bits per symbol, and subtracting framing and coding overheads. Then at the decision Block 505 it will be compared to the targeted service rates, and in turn results in two different paths. With this invention, the path led to Block 510 of retraining with a new PSD negotiation is implemented; otherwise, the path led to Block 506 of continuing the rest of protocol stages is the same as the prior art. Once the final stage is finished, it enters the Showtime stage at Block 507.

Ideally in Channel Discovery stage, all information including the signal, noise, attenuation, sender's PSD level etc can be gathered. However, the noise measured in this stage will not be final; the strong crosstalk in the DSL system will be handled in the next stage Training & Analysis. Once the pre-coder and post-coder are trained for the crosstalk, it is generally not desirable to adjust the PSD level again; in this regard, the standard does not allow any PSD change from this point. After the crosstalk is mostly cancelled, the real noise floor can then be used to estimate the final achievable rate. Once it decides whether the PSD level is too low or enough, it may decide the next step. If the PSD level is too low, it may trigger a retrain back to Channel Discovery stage. In there, they may propose the PSD upshifts in order to achieve higher rates. On the other hand, if it decides the PSD level is enough to support the target service rate, it may continue into the final stage and transition into Showtime.

Although the present invention has been described in terms of a preferred embodiment, it will be apparent to those skilled in the art that many alterations and modifications may be made to such embodiments without departing from the teachings of the present invention. For example, while the above description uses VDSL as an example, the teachings of this disclosure can also be applied to other DSL technologies, such as G.fast and other members of the family of technologies generally known as xDSL. It is noted that typically, the retrain portion of Block 210 may happen in later stages instead of the proposed Stage 304. For the Power/PSD level decision flow, the additions of message fields exchanged are possible to be appended into other messages, instead of the Message 404 and 405. The scope of the invention should, therefore, be determined not with reference to the above description, but instead should be determined with reference to the appended claims along with their full scope of equivalents.

What is claimed is:

1. A system for optimizing an achievable rate when a power spectrum density (PSD) reduction based on a loop distance is compromised by a high noise floor, which an exchange protocol configured to include extra information fields and result in a retrain to set PSD levels, said system comprising a processor and memory configured to execute code comprising:
logic for executing a noise measuring algorithm after a crosstalk cancellation stage; and
logic for executing a signal measuring algorithm which is compared against a known PSD level at a transmitter end; and
a signal-to-noise-ratio (SNR) and data rate estimation algorithm which:
i) calculates an estimated data bit-load allocation on one of a set of subcarriers based on the subcarrier's SNR; and
ii) sums up the estimated bit-load allocations on the set of subcarriers; and
iii) determines an estimated data rate by total bits per symbol and number of symbols per second;
a decision block which compares the estimated data rate and a target service rate, in order to:
i) continue a training stage if the target service rate is met; or
ii) retrain to set new parameters to negotiate the PSD levels or PBO levels to meet the target service rate.

2. The system of claim 1, wherein said system is implemented in a digital subscriber line (DSL) transceiver.

3. The system of claim 2, wherein said system implements an initialization protocol between central office (CO) and customer premises equipment (CPE) ends, to prepare the transceivers that comprise transmitters and receivers for data transfer service.

4. The system of claim 3, wherein said initialization protocol comprises at least one of a Channel Discovery stage, a Training & Analysis stage and an Exchange stage.

5. The system of claim 3, wherein said initialization protocol allows the transceivers to execute the noise measuring algorithm, the signal measuring algorithm, the SNR and data rate estimation algorithm and allows the transceivers to exchange information messages.

6. The system of claim 1, wherein said PSD reduction is a technique of crosstalk mitigation for near-far problems, whereas the PSD reduction is purely based on the loop distance, resulting in the shorter loop distance the transceivers have power back-off (PBO) while the longer loop distance the transceivers have no power back-off.

7. The system of claim 6, wherein said PBO is decided by the transceivers and the peer transmitters' PSD level and measured received signals so that the transceivers and the peer transmitters are configured to derive a signal and loop attenuation.

8. The system of claim 1, wherein said a crosstalk cancellation is a technique to align neighboring DSL lines to mathematically leave main signals and crosstalk on orthogonal terms and manage to cancel the crosstalk with matrix operations.

9. The system of claim 8, wherein said matrix operations involved on an upstream direction are post-coders being implemented at the CO end, said matrix operations involved on a downstream direction are pre-coders being implemented at the CO end as well, and the matrix operations are handled by a vectoring control entity (VCE) module at the CO end.

10. A method for use in a digital subscriber line (DSL) communications system comprising step of:
(a) receiving a DSL signal transmitted by a peer;
(b) transmitting a DSL signal to a peer;
(c) processing data in the received DSL signal;
(d) detecting a valid data pattern after an non-valid data period has expired;
(e) measuring the valid data pattern of the DSL signal during a predetermined period of time;
(f) determining a signal power by analyzing the valid data pattern of the measured DSL;
(g) estimating a signal attenuation by the signal power and received information of a transmitter's PSD level and determine an electrical length;
(h) adjusting the transmitter's PSD level with power back-off (PBO) according to a predefined rule associating with the electrical length;
(i) negotiating a new power back-off PSD level offset upon an estimation of data rate being compared to a target service rate; and
(j) retraining from steps (a)-(i) to start a new message exchange for the power back-off to be set.

11. The method of claim 10, wherein a detection regarding the reception of data during step (d) is performed in time domain and in frequency domain by fast Fourier transform.

12. The method of claim 10, wherein a measurement regarding the reception of DSL signal during step (e) is performed in time domain and in frequency domain by fast Fourier transform.

13. The method of claim 10, wherein an analysis regarding the measured signal during step (f) is effectuated using algorithm to compute the mean and variance over a set value of predefined repeated symbols in frequency domain after fast Fourier transform.

14. The method of claim 10, wherein an estimation regarding the signal attenuation during step (g) is evaluated by determining a gap between the transmitter's PSD level and receiver's measured signal PSD in frequency domain.

15. The method of claim 10, wherein the electrical length during step (g) is defined by a predefined formula representing a physical loop distance between a DSL system and a peer DSL system and a value evaluated across the signal attenuation in utilized frequency bandwidths.

16. The method of claim 10, wherein said predefined rule during step (h) is involved with parameter a parameter b and the electrical length kl0 and the subcarrier's frequency.

17. The method of claim 10, wherein said estimation of data rate during step (i) is further comprising:
a final measurement of signal-to-noise ratio (SNR) on frequency subcarriers across available bandwidths; and
an algorithm of bit-load allocation that bases on the SNR of individual subcarrier to obtain an overall bit loads of a symbol; and
a final calculation of data rate attainable with the symbol rate, coding and framing overhead.

18. The method of claim 10, wherein said target service rate during step (i) is designated during the VDSL protocol, whereas a service rate tier that a customer subscribes from a service provider, and which is lower than the attainable rate under the customer loop's distance and noises.

19. The method of claim 18, wherein said protocol consists of several stages comprising Channel Discovery stage, Training & Analysis stage and Exchange stage; the Channel Discovery stage aims to discover channel characteristics of the loop distance, static environment noises, radio frequency interferences; the Training & Analysis stage aims to finalize parameters of gain controls, equalizers and PSD levels; and the Exchange stage aims to determine bit-load allocations, rate decisions and information exchanges to prepare for data services.

20. The method of claim 10, wherein said retraining the process during step (j) is an implementation when either side of the DSL transceivers decide not to continue the protocol and restart a new protocol in order to set different parameters which are determined in the Channel Discovery stage of the protocol.
